(19) United States
(12) Patent Application Publication
(10) Pub. No.: US 2021/0245357 A1
(43) Pub. Date: Aug. 12, 2021

(54) MAGNETIC TOOL HOLDER

(71) Applicant: JEI MOU INDUSTRIAL CO., LTD., Taichung City (TW)

(72) Inventor: Po-Shen Chen, Taichung City (TW)

(21) Appl. No.: 16/828,180

(22) Filed: Mar. 24, 2020

(30) Foreign Application Priority Data
Feb. 10, 2020 (TW) 109104066

(51) Int. Cl. B25H 3/00

(52) U.S. Cl. CPC B25H 3/003

(57) ABSTRACT

A magnetic tool holder includes a body and a first magnetic member. The body includes a front side and a rear side opposite to the front side. The front side includes a first insertion groove and a second insertion groove. Each of the first insertion groove and the second insertion groove extends from the first side towards the rear side. The first magnetic member mounted to the body and located adjacent to the rear side. The first magnetic member includes a first end located between the first insertion groove and the rear side and a second end located between the second insertion groove and the rear side.

### BACKGROUND OF THE INVENTION

The present invention relates to a tool holder and, more particularly, to a magnetic tool holder.

Taiwan Utility Model No. M424221 discloses an improved structure of a tool holder including a base, a lid, and a plurality of magnetic members mounted between the base and the lid. The lid is coupled to an inner edge of the base and is suitable for a tool holder without a connecting outer periphery. The plurality of magnetic members provides magnetic force for attraction to a fixed object made of metal. The lid has a planar outer surface for attraction to the fixed object.

The tool holder includes a plurality of grooves for receiving sockets, with each groove having a flange on an inner periphery thereof for retaining a respective socket, preventing the respective socket from falling out. However, insertion of the respective socket into the respective groove is impeded by the flange, such that the respective socket requires to be forcibly inserted into the respective groove. Furthermore, the flange of the respective groove is apt to wear during use, adversely affecting the holding effect.

Thus, a need exists for a novel magnetic tool holder that mitigates and/or obviates the above drawbacks.

### BRIEF SUMMARY OF THE INVENTION

The primary objective of the present invention is to provide a magnetic tool holder including a body and a first magnetic member. The body includes a front side and a rear side opposite to the front side. The front side includes a first insertion groove and a second insertion groove. Each of the first insertion groove and the second insertion groove extends from the first side towards the rear side. The first magnetic member mounted to the body and located adjacent to the rear side. The first magnetic member includes a first end located between the first insertion groove and the rear side and a second end located between the second insertion groove and the rear side.

In an example, the rear side includes a first receiving groove. The first magnetic member is mounted in the first receiving groove. A back board is disposed to the body and is mounted to the rear side. The back board abuts a side of the first magnetic member opposite to the front side.

In an example, the front side includes at least one third insertion groove located on a side of the second insertion groove opposite to the first insertion groove. The at least one third insertion groove extends from the front side towards the rear side. The magnetic tool holder further includes a second magnetic member mounted to the body and located adjacent to the rear side. The second magnetic member includes a first end located between the second insertion groove and the rear side and a second end located between the at least one third insertion groove and the rear side. The rear side includes a second receiving groove. The second magnetic member is mounted in the second receiving groove. The back board abuts against a side of the second magnetic member opposite to the front side.

In an example, the at least one third insertion groove includes a plurality of third insertion grooves arranged in sequence on the side of the second insertion groove opposite to the first insertion groove. Each of the plurality of third insertion groove extends from the front side towards the rear side. The magnetic tool holder includes a plurality of third magnetic members mounted to the body and located adjacent to the rear side. Each of the plurality of third magnetic members includes a first end located between a respective one of the plurality of third insertion grooves and the rear side and a second end located between the rear side and one of the plurality of third insertion grooves next to the respective one of the plurality of third insertion grooves. The rear side includes a plurality of third receiving grooves. The plurality of third magnetic members is received in the plurality of third receiving grooves, respectively. The back board abuts against a side of each of the plurality of third magnetic members opposite to the front side.

In an example, the magnetic tool holder further includes a fourth magnetic member and a fifth magnetic member. Each of the fourth magnetic member and the fifth magnetic member is mounted to the body and is located adjacent to the rear side. The fourth magnetic member is disposed between the first insertion groove and the rear side and is located adjacent to a sidewall of the first insertion groove opposite to the second insertion groove. The fifth magnetic member is disposed between the rear side and one of the plurality of third insertion grooves most remote from the first insertion groove. The rear side further includes a fourth receiving groove and a fifth receiving grove. The fourth magnetic member is mounted in the fourth receiving groove. The fifth magnetic member is mounted in the fifth receiving groove. The back board abuts against a side of the fourth magnetic member opposite to the front side and abuts against a side of the fifth magnetic member opposite to the front side.

In an example, the back board includes a first annular protrusion (230a), a second annular protrusion (231a), a plurality of third annular protrusions (232a), a fourth annular protrusion (233a), and a fifth annular protrusion (234a). The first annular protrusion (230a) defines a first recess (235a). The second annular protrusion (231a) defines a second recess (236a). Each of the plurality of third annular protrusions (232a) defines a third recess (237a). The fourth annular protrusion (233a) defines a fourth recess (238a). The fifth annular protrusion (234a) defines a fifth recess (239a). The first magnetic member is mounted in the first recess (235a). The first annular protrusion (230a) is inserted into the first receiving groove. The second magnetic member is mounted in the second recess (236a). The second annular protrusion (231a) is inserted into the second receiving groove. The plurality of third magnetic members is mounted in the third recesses (237a), respectively. The third annular protrusions (232a) is inserted into the plurality of third receiving grooves, respectively. The fourth magnetic member is mounted in the fourth recess (238a). The fourth annular protrusion (233a) is inserted into the fourth receiving groove. The fifth magnetic member is mounted in the fifth recess (239a). The fifth annular protrusion (234a) is inserted into the fifth receiving groove.

The present invention will become clearer in light of the following detailed description of illustrative embodiments of this invention described in connection with the drawings.

### DESCRIPTION OF THE DRAWINGS

FIG. 1 is a perspective view of a magnetic tool holder of a first embodiment according to the present invention.

FIG. 2 is an exploded, perspective view of the magnetic tool holder of FIG. 1.

FIG. 3 is a top view of the magnetic tool holder of FIG. 1.

FIG. 4 is a cross sectional view of the magnetic tool holder of FIG. 1.

FIG. 5 is an enlarged view of a portion of FIG. 4 with two sockets 90 held by the magnetic tool holder.

FIG. 6 is an exploded, perspective view of a magnetic tool holder of a second embodiment according to the present invention.

FIG. 7 is a cross sectional view of the magnetic tool holder of FIG. 6.

### DETAILED DESCRIPTION OF THE INVENTION

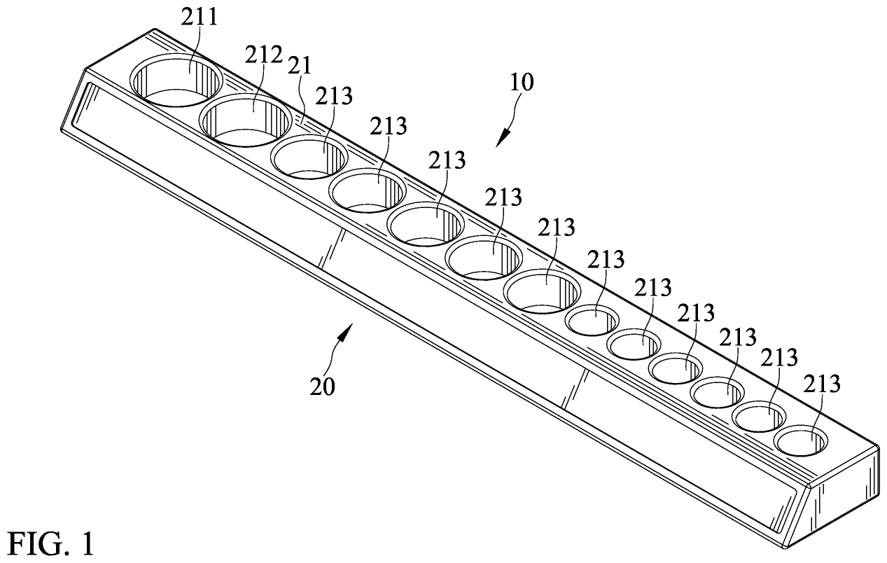

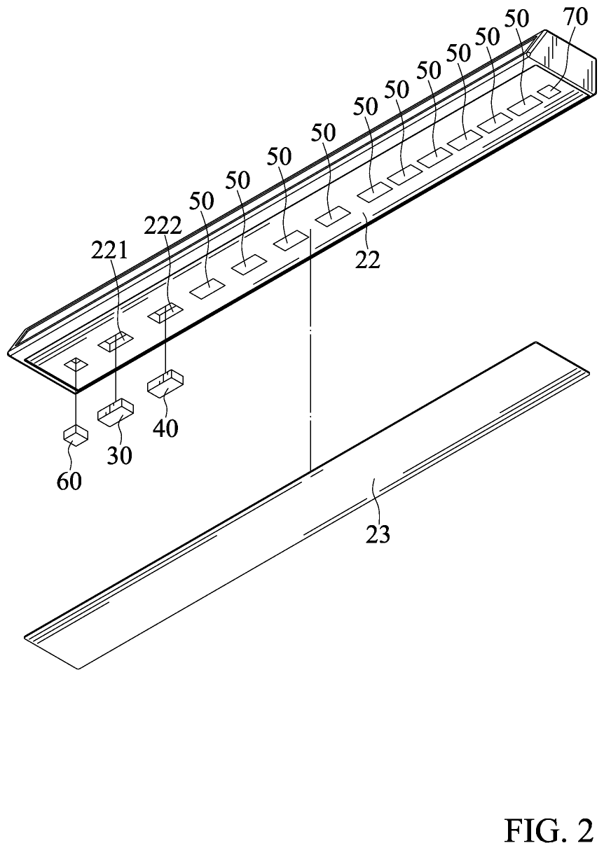

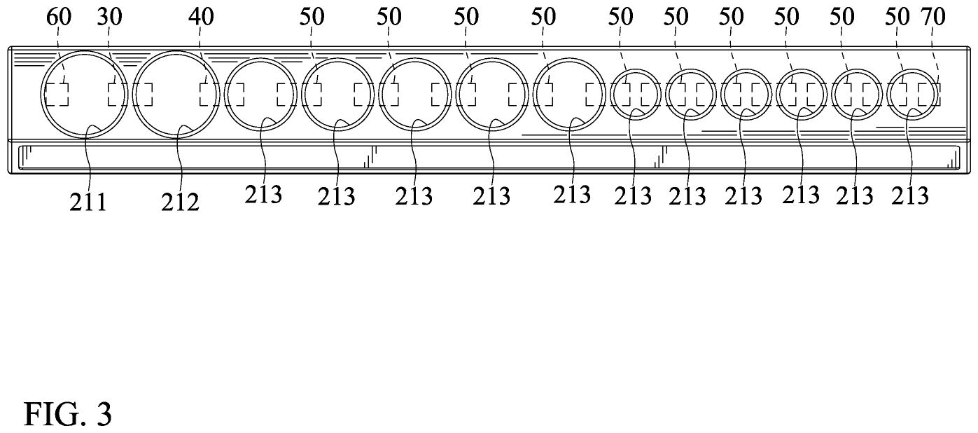

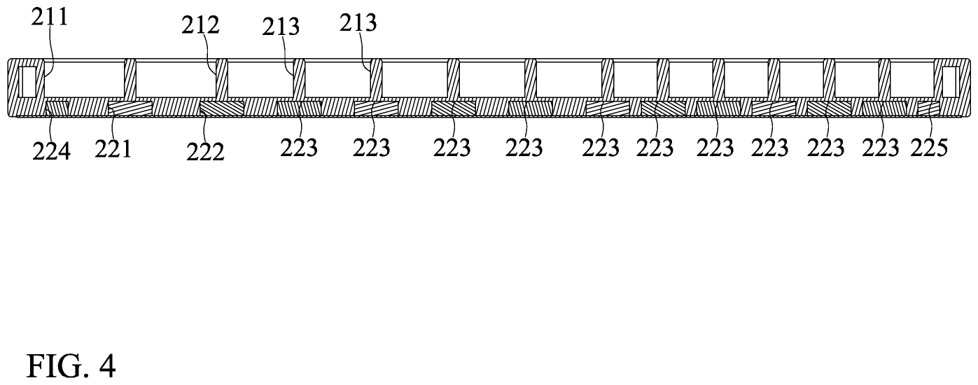

With reference to FIGS. 1-4, a magnetic tool holder of a first embodiment according to the present invention includes a body 20 and a first magnetic member 30. The body 20 includes a front side 21 and a rear side 22 opposite to the front side 21. The front side 21 includes a first insertion groove 211 and a second insertion groove 212. Each of the first insertion groove 211 and the second insertion groove 212 extends from the first side 21 towards the rear side 22.

The first magnetic member 30 is mounted to the body 20 and is located adjacent to the rear side 22. The first magnetic member 30 includes a first end located between the first insertion groove 211 and the rear side 22 and a second end located between the second insertion groove 212 and the rear side 22.

The rear side 22 includes a first receiving groove 221. The first magnetic member 30 is mounted in the first receiving groove 221. A back board 23 is disposed to the body 20 and is mounted to the rear side 22. The back board 23 abuts against a side of the first magnetic member 30 opposite to the front side 21.

The front side 21 includes at least one third insertion groove 213 located on a side of the second insertion groove 212 opposite to the first insertion groove 211. The at least one third insertion groove 213 extends from the front side 21 towards the rear side 22. The magnetic tool holder 10 further includes a second magnetic member 40 mounted to the body 20 and located adjacent to the rear side 22. The second magnetic member 40 includes a first end located between the second insertion groove 212 and the rear side 22 and a second end located between the at least one third insertion groove 213 and the rear side 22. The rear side 22 includes a second receiving groove 222. The second magnetic member 40 is mounted in the second receiving groove 222. The back board 23 abuts against a side of the second magnetic member 40 opposite to the front side 21.

In this embodiment, the at least one third insertion groove 213 includes a plurality of third insertion grooves 213 arranged in sequence on the side of the second insertion groove 212 opposite to the first insertion groove 211. Each of the plurality of third insertion groove 213 extends from the front side 21 towards the rear side 22. The magnetic tool holder 10 includes a plurality of third magnetic members 50 mounted to the body 20 and located adjacent to the rear side 22. Each of the plurality of third magnetic members 50 includes a first end located between a respective one of the plurality of third insertion grooves 213 and the rear side 22 and a second end located between the rear side 22 and one of the plurality of third insertion grooves 213 next to the respective one of the plurality of third insertion grooves 213. The rear side 22 includes a plurality of third receiving grooves 223. The plurality of third magnetic members 50 is received in the plurality of third receiving grooves 223, respectively. The back board 23 abuts against a side of each of the plurality of third magnetic members 50 opposite to the front side 21.

The magnetic tool holder 10 further includes a fourth magnetic member 60 and a fifth magnetic member 70. Each of the fourth magnetic member 60 and the fifth magnetic member 70 is mounted to the body 20 and is located adjacent to the rear side 22. The fourth magnetic member 60 is disposed between the first insertion groove 211 and the rear side 22 and is located adjacent to a sidewall of the first insertion groove 211 opposite to the second insertion groove 212. The fifth magnetic member 70 is disposed between the rear side 22 and one of the plurality of third insertion grooves 213 most remote from the first insertion groove 211. The rear side 22 further includes a fourth receiving groove 224 and a fifth receiving grove 225. The fourth magnetic member 60 is mounted in the fourth receiving groove 224. The fifth magnetic member 60 is mounted in the fifth receiving groove 225. The back board 23 abuts against a side of the fourth magnetic member 60 opposite to the front side 21 and abuts against a side of the fifth magnetic member 70 opposite to the front side 21.

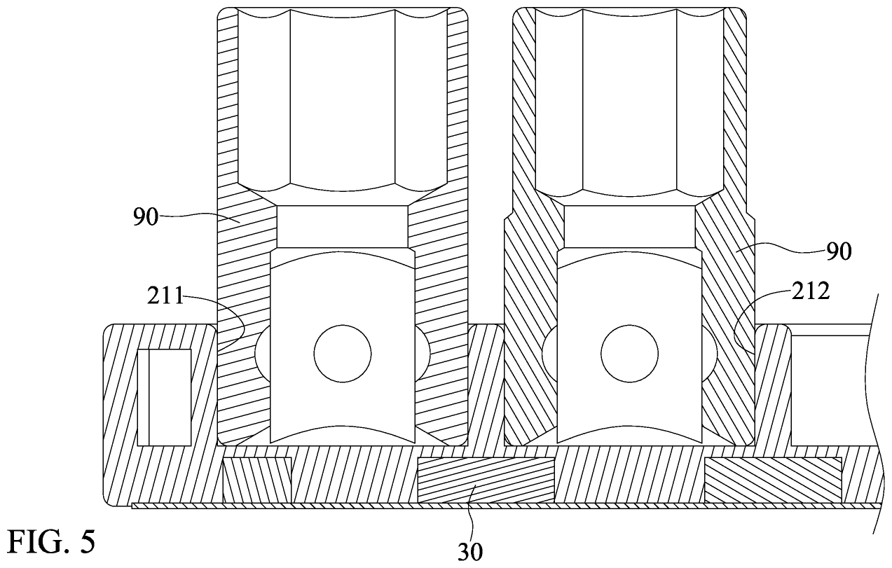

With reference to FIG. 5, in use of the magnetic tool holder 10 according to the present invention, the magnetic tool holder 10 can securely attract sockets 90 through the above structure. Due to provision of the first magnetic member 30 extending across the first insertion groove 211 and the second insertion groove 212, the strongest portion of the magnetic field generated by the first magnetic member 30 is located at the marginal portions of the first insertion groove 211 and the second insertion groove 212. When two sockets 90 are placed into the first insertion groove 211 and the second insertion groove 212, the metal portion of the two sockets 90 is aligned with the first magnetic member 30 to provide the best magnetic attraction effect. Furthermore, the first magnetic member 30 aligns with the first insertion groove 211 and the second insertion groove 212 simultaneously to reduce the amount of magnets being used.

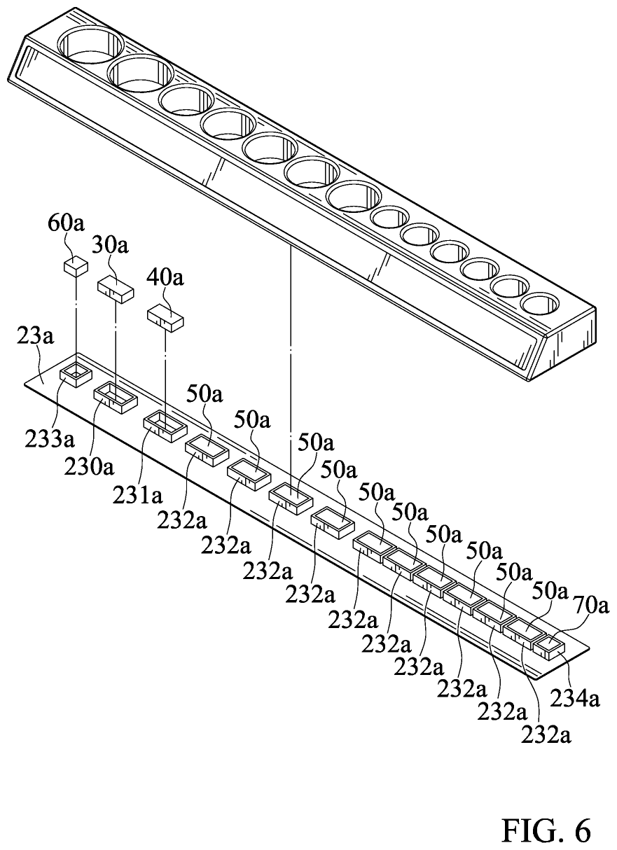

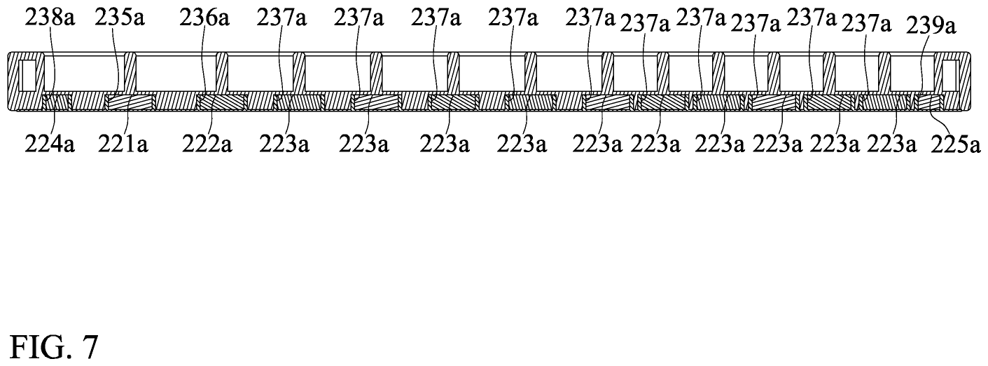

FIGS. 6 and 7 show a magnetic tool holder of a second embodiment according to the present invention. The second embodiment is substantially the same as the first embodiment except that the back board 23a includes a first annular protrusion (230a) 230a, a second annular protrusion (231a) 231a, a plurality of third annular protrusions (232a) 232a, a fourth annular protrusion (233a) 233a, and a fifth annular protrusion (234a) 234a. The first annular protrusion (230a) 230a defines a first recess (235a) 235a. The second annular protrusion (231a) 231a defines a second recess (236a) 236a. Each of the plurality of third annular protrusions (232a) 232a defines a third recess (237a) 237a. The fourth annular protrusion (233a) 233a defines a fourth recess (238a) 238a. The fifth annular protrusion (234a) 234a defines a fifth recess (239a) 239a. The first magnetic member 30a is mounted in the first recess (235a) 235a. The first annular protrusion (230a) 230a is inserted into the first receiving groove 221a. The second magnetic member 40a is mounted in the second recess (236a) 236a. The second annular protrusion (231a) 231a is inserted into the second receiving groove 222a. The plurality of third magnetic members 50a is mounted in the third recesses (237a) 237a, respectively. The third annular protrusions (232a) 232a is inserted into the plurality of third receiving grooves 223a, respectively. The fourth magnetic member 60a is mounted in the fourth recess (238a) 238a. The fourth annular protrusion (233a) 233a is inserted into the fourth receiving groove 224a. The fifth magnetic member 70a is mounted in the fifth recess (239a) 239a. The fifth annular protrusion (234a) 234a is inserted into the fifth receiving groove 225a.

Although specific embodiments have been illustrated and described, numerous modifications and variations are still possible without departing from the scope of the invention. The scope of the invention is limited by the accompanying claims.

1. A magnetic tool holder comprising:
a body including a front side and a rear side opposite to the front side, wherein the front side includes a first insertion groove and a second insertion groove, and wherein each of the first insertion groove and the second insertion groove extends from the first side towards the rear side; and
a first magnetic member mounted to the body and located adjacent to the rear side, wherein the first magnetic member includes a first end located between the first insertion groove and the rear side and a second end located between the second insertion groove and the rear side.

2. The magnetic tool holder as claimed in claim 1, wherein the rear side includes a first receiving groove, wherein the first magnetic member is mounted in the first receiving groove, wherein a back board is disposed to the body and is mounted to the rear side, and wherein the back board abuts a side of the first magnetic member opposite to the front side.

3. The magnetic tool holder as claimed in claim 2, wherein the front side includes at least one third insertion groove located on a side of the second insertion groove opposite to the first insertion groove, wherein the at least one third insertion groove extends from the front side towards the rear side, wherein the magnetic tool holder further includes a second magnetic member mounted to the body and located adjacent to the rear side, wherein the second magnetic member includes a first end located between the second insertion groove and the rear side and a second end located between the at least one third insertion groove and the rear side, wherein the rear side includes a second receiving groove, wherein the second magnetic member is mounted in the second receiving groove, and wherein the back board abuts against a side of the second magnetic member opposite to the front side.

4. The magnetic tool holder as claimed in claim 3, wherein the at least one third insertion groove includes a plurality of third insertion grooves arranged in sequence on the side of the second insertion groove opposite to the first insertion groove, wherein each of the plurality of third insertion groove extends from the front side towards the rear side, wherein the magnetic tool holder includes a plurality of third magnetic members mounted to the body and located adjacent to the rear side, wherein each of the plurality of third magnetic members includes a first end located between a respective one of the plurality of third insertion grooves and the rear side and a second end located between the rear side and one of the plurality of third insertion grooves next to the respective one of the plurality of third insertion grooves, wherein the rear side includes a plurality of third receiving grooves, wherein the plurality of third magnetic members is received in the plurality of third receiving grooves, respectively, and wherein the back board abuts against a side of each of the plurality of third magnetic members opposite to the front side.

5. The magnetic tool holder as claimed in claim 4, wherein the magnetic tool holder further includes a fourth magnetic member and a fifth magnetic member, wherein each of the fourth magnetic member and the fifth magnetic member is mounted to the body and is located adjacent to the rear side, wherein the fourth magnetic member is disposed between the first insertion groove and the rear side and is located adjacent to a sidewall of the first insertion groove opposite to the second insertion groove, wherein the fifth magnetic member is disposed between the rear side and one of the plurality of third insertion grooves most remote from the first insertion groove, wherein the rear side further includes a fourth receiving groove and a fifth receiving grove, wherein the fourth magnetic member is mounted in the fourth receiving groove, wherein the fifth magnetic member is mounted in the fifth receiving groove, and wherein the back board abuts against a side of the fourth magnetic member opposite to the front side and abuts against a side of the fifth magnetic member opposite to the front side.

6. The magnetic tool holder as claimed in claim 5, wherein the back board includes a first annular protrusion, a second annular protrusion, a plurality of third annular protrusions, a fourth annular protrusion, and a fifth annular protrusion, wherein the first annular protrusion defines a first recess, wherein the second annular protrusion defines a second recess, wherein each of the plurality of third annular protrusions defines a third recess, wherein the fourth annular protrusion defines a fourth recess, wherein the fifth annular protrusion defines a fifth recess, wherein the first magnetic member is mounted in the first recess, wherein the first annular protrusion is inserted into the first receiving groove, wherein the second magnetic member is mounted in the second recess, wherein the second annular protrusion is inserted into the second receiving groove, wherein the plurality of third magnetic members is mounted in the third recesses, respectively, wherein the third annular protrusions is inserted into the plurality of third receiving grooves, respectively, wherein the fourth magnetic member is mounted in the fourth recess, wherein the fourth annular protrusion is inserted into the fourth receiving groove, wherein the fifth magnetic member is mounted in the fifth recess, and wherein the fifth annular protrusion is inserted into the fifth receiving groove.
